(19) United States
(12) Patent Application Publication
(10) Pub. No.: US 2023/0213351 A1
(43) Pub. Date: Jul. 6, 2023

(54) SYSTEM AND METHOD FOR NAVIGATION

(71) Applicant: OmniEyes Co., Ltd. Taiwan Branch, Taipei City (TW)

(72) Inventors: Yi Yen WANG, Tainan City (TW); Chia Chin HO, Chiayi County (TW); Chung Sheng LAI, Taipei City (TW); Chun Ting CHOU, New Taipei City (TW); Te Chuan CHIU, Taipei City (TW); Ai Chun PANG, Taipei City (TW); Ling Yuan CHEN, Taipei City (TW); Ruei Kai CHENG, Taipei City (TW); Chih En HUANG, Taoyuan City (TW); Ren Jie PAN, Taipei City (TW)

(21) Appl. No.: 17/565,851

(22) Filed: Dec. 30, 2021

(51) Int. Cl. G01C 21/36; G06V 10/74; G06V 20/58; G06F 3/0484; G06F 16/55; G06F 16/53; G01C 21/32

(52) U.S. Cl. CPC G01C 21/3679; G06V 10/761; G06V 20/58; G06F 3/0484; G06F 16/55; G06F 16/53; G01C 21/32

(57) ABSTRACT

The present invention provides an automatic system for visual guidance and navigation using real-time visual anchor point detection, which includes an edge device, a cloud device, and a landmark database; the system of the present invention provides users with navigation directions via visual landmarks. A candidate visual landmark image is selected from the database; the system of the present invention can calculate the time of day, the current weather condition, the current season, etc. In addition, the system of the present invention can use the camera on the dashboard of the vehicle, the camera in the smartphone, or other cameras to collect real-time images; the system of the present invention can also provide feedback on the visibility or salience of landmarks to improve the visual landmark images obtained by subsequent users.

### FIELD OF THE INVENTION

The present invention provides a system and method for visual guidance using real-time visual anchor point detection, and in particular, relates to a method for providing a user with an automatic update system of real and accurate landmark images.

### BACKGROUND OF THE INVENTION

A vehicle navigation system enables drivers to search for the destination through navigation instructions, mainly by promoting the estimated distance and route map to guide the user to the destination. The navigation system usually provides step-by-step instructions to a driver and notifies the driver to turn left or right at the intersection around tens or hundreds of meters in advance.

However, due to the positioning error issue of GPS, the instructions sometimes are delayed or inaccurate such that the driver may not be able to take an action at the right moment. Furthermore, the driver was expected to recognize the street name sign by matching the instruction given by the navigation system with the image template. This may consume a lot of effort and distract the driver from focusing on road conditions.

The current navigation system not only provides information about the street names and distances but also a simulation map or schematic diagram of the real scene. However, most schematic diagrams or schematic buildings will require the driver to pay overtime to find out the correct sign. Although it seems to give more information, it is easy to distract the user's attention from the road conditions and actually causes the user to be more dangerous.

Drivers only have a few seconds to complete the series of actions from obtaining the information, judging the information to decide to turn. Therefore, the information provided by the navigation system should be simple and easy to understand. It is preferable to have the same picture or photograph as the real scene so that the user can make the decision whether to turn or not with the clearest information without conversion.

Some manufacturers have proposed to enhance navigation information through landmark images. The landmark images of all the routes were defined before the navigation system left the factory, they can't really match the actual environment. There are often misjudgments when using it. Consequently, how to effectively update the navigation system with real-time landmark images has become an urgent issue and challenge.

### SUMMARY OF THE INVENTION

The present invention can automatically plan a route for the user and prompt the user mainly through distance, street name, and building number, and it generates navigation directions based on the route. For example, the system can provide the user with instructions such as “go forward a quarter of a mile and then turn right into Maple Street”. However, it is difficult for the user to accurately estimate the distance indicated by the navigation prompt, and it is not always easy to find the street sign prompted by the navigation system. In addition, some areas have fuzzy street and road signs, which makes it more difficult for users to drive a vehicle while looking for landmarks.

In order to provide the user with a navigation system similar to the guidance of a real person, it is better to refer to the prominently marked images in the travel route to enhance the navigation and guidance quality, and the prominently marked may be visually prominent buildings or billboards. It can be called “Visual Anchor” in the present invention. Therefore, the navigation directions that the system of the present invention can be “at a quarter-mile, you will see the McDonald's restaurant on your right, then turn right into Maple Street”. The user can approach the position of the destination (ex, street address or coordinates) so that the system can automatically select the appropriate visual landmark when generating navigational directions.

In view of this, the present invention provides a system capable of realizing a more intuitive and accurate navigation system. In the system, in addition to providing voice instructions to users, landmark images of visual anchor points are captured by human eyes. When the user's vehicle approaches the landmark, the present invention can provide the user with an image of the real landmark. At the same time, the present invention will recognize a visual anchor point (for example, a signboard) and display the signboard shown on the user interface. The visual anchor point can guide the user through the detected signboard, rather than by distance. In this way, the user can focus more on driving and travelling through landmark images without having to use his own experience to calculate the distance described by the navigation system, which greatly improves the user's driving concentration and efficiency in driving the vehicle.

The present invention provides an automatic system for visual guidance navigation using real-time visual anchor point detection, which includes an edge device, a cloud device, and a landmark database, wherein the edge device includes: a camera, which is configured on a user's preset location, which can capture a real-time image while the user is driving a vehicle; a user interface, which provides a user operation, which can view information provided by an application program, and enter the user data and visual anchor; a location module for determining the current geographic location of the vehicle; a wireless network module for transmitting the current geographic location of the vehicle and a destination set by the user to the wireless network module; a processer, which will perform an edge computing, can process the real-time image and the current geographic location of the vehicle to provide the user with a driving instruction through the user interface, and the driving instruction includes a candidate visual landmark image; a memory device for caching a reference landmark image received from the data in the wireless network module; and a navigation application module, the user can set the destination, transmitting the vehicle position and destination to the wireless network module, obtaining a route instruction and a landmark image information, and displaying the processing result and driving instruction to the user on the user interface; wherein, the cloud device includes: a navigation instruction generator, which generates a navigation instruction, and an action intersection; a route module, which can query the route from the landmark database according to the current geographical location of the vehicle and the destination; a navigation instruction generation module, which generates the navigation instruction according to the route of the route module, and defines the action intersection according to the navigation instruction; a landmark query module, which queries the visual landmark image from the landmark database according to the action intersection; and a landmark update module, which automatically updates the visual landmark image of the landmark database.

Wherein, the landmark database includes landmark records, visual landmark images, intersections where landmarks are located, and latitude and longitude of landmarks.

Preferably, the present invention includes a map database, and the map database includes map information such as intersections, latitude and longitude of intersections, and road travel directions.

The present invention further provides a method for visual guidance navigation using real-time visual anchor point detection, which includes: obtaining a route for guiding a vehicle user to a destination through a processing module; retrieving a visual landmark image set along the route from a database through the processing module; capturing a real-time landmark image from a present location of the user during navigation along the route through a camera; performing an edge calculation by using the retrieved visual landmark image and the collected real-time landmark image through the processing module, wherein the real-time image and the geographic location of the vehicle can be processed; and the user interface provides the user with a driving instruction including a candidate visual landmark image.

The present invention further provides a method for providing driving directions, receiving a request for driving directions to a destination from a user of the vehicle through a user interface operating in the vehicle; capturing real-time landmark images from a present location of the user during navigation along the route through a camera; using the retrieved visual landmark images and the collected real-time landmark images, and performing an edge calculation through the processing module, the real-time images and the geographic location of the vehicle can be processed; providing the user with a driving instruction via the user interface, the driving instruction including a candidate visual landmark image.

Preferably, the processing module of the present invention further comprises: receiving a candidate visual landmark image at the current geographic location of the vehicle, and comparing the captured real-time image with the received candidate visual landmark image; wherein the candidate visual landmarks are compared to determine whether the candidate visual landmark image is visible in the real-time image. When the candidate's visual landmark image is not visible in the real-time image, the candidate's visual landmark image is deleted from the instruction.

Preferably, the present invention determines whether the captured real-time image depicts an object of a predetermined object, and determines whether the object is visible within the real-time image based on at least one of the size or color of the object; if it is determined that the object is visible, the object is selected as the visual landmark image.

Preferably, a certain predetermined category of the present invention includes storefront signs, buildings, installation art, bridges, texts, vehicles, billboards, traffic lights or portraits.

Preferably, the processing module of the present invention further comprises: determining whether the captured real-time image depicts an object of a predetermined category, and determining, based on at least one of the size or color of the object, where the object is located. Whether the real-time image is visible; if it is determined that the pair is not visible, the captured real-time image is stored in the memory device and transmitted to the user interface, and the user can rely on subjective judging and selecting the best visual landmark image, performing a voting action, and sending the voting action back to the processing module; the processing module can perform calculations according to the voting results to obtain a best visual landmark image, and transmit the best visual landmark image to the landmark database as the subsequent visual landmark image.

Preferably, the processing module of the present invention further includes: the user is a plurality of users, which can select the best visual landmark image according to the subjective judgment of the plurality of users, and perform a voting action to vote the votes. The action is sent back to the processing module; the processing module can perform calculations according to the plurality of voting results of the plurality of users to obtain the best visual landmark image, and transmit the best visual landmark image to the landmark database is used as the subsequent visual landmark image.

The present invention further includes a method for automatically updating the visual landmark images in the landmark database, comprising:
(a) A processing module uses a filter rule to filter visual landmark images collected from the vehicles and delete an incorrect visual landmark image;
(b) Calculating the similarity between a real-time visual landmark image collected by an edge device and the visual landmark image in the landmark database;
(c) The similarity ranking is performed on the real-time visual landmark images, and a plurality of visual landmark images with low similarity scores are selected as a new candidate visual landmark image;
(d) Checking whether the new candidate visual landmark image has been stored in the landmark database; if so, update the last update time in the landmark database;
(e) If the new candidate visual landmark image is not in the landmark database, then it is a new visual landmark image, creating a new landmark record in the landmark database; and
(f) Checking whether all landmark records of the current geographic location of the vehicle in the landmark database have reached the time limit to be updated, and if they have expired, delete the landmark records.

In the method for automatically updating the visual landmark images in the landmark database of the present invention, the filtering rule is a frame area filtering rule or an aspect ratio parameter filtering rule.

The area parameter (frame area) filtering rules are the characteristics of the detected candidate landmark pictures themselves, and filter the candidate landmark pictures with unreasonable picture area:
(a) Filter smaller landmark images. For example, when the area of the landmark image is less than 1/1000 of the screen, the next best embodiment is that the area is less than 1/5000 of the screen, and the best embodiment is that the area is less than 1/10000 of the screen, then this landmark image will be filtered out (probably too far away);
(b) Filter the landmark images that are too large. For example, the area of the landmark image exceeds ¼ of the screen. The second best embodiment is that the area exceeds ⅓ of the screen. The best embodiment is that the area exceeds ½ of the screen, then these landmark image images will be filtered out (unreasonable placemarks).

The aspect ratio parameter is used to filter landmark maps with unreasonable rules. A reasonable aspect ratio should be greater than ⅕, the second-best is greater than ¼, and the best is greater than ⅓. In addition, a reasonable aspect ratio should be greater than ⅕. The aspect ratio should be less than 5, the second-best is less than 4, the best is less than 3, and in another preferred embodiment, the best aspect ratio can be between ⅓ to 3.

In the present invention, the features of the landmark pictures are further extracted through the convolutional neural network model. The input parameter of the model is the original frame of the landmark image (raw frame), and the output is the feature of the image. Use this feature to calculate the similarity between landmark images.

The system of the present invention provides the user with navigational directions using visual landmarks that may be visible when the user arrives at the corresponding geographic location. In a preferred embodiment, the system selects a candidate visual landmark image from an extensive visual landmark database. The system calculates the time of day, current weather conditions, current season, and more. In addition, the system can collect real-time images through a camera on the vehicle's dashboard, a camera in a smartphone, or another user's camera. The system may also provide feedback on the visibility or prominence of the landmark to improve the visual landmark imagery for subsequent users of the system.

### BRIEF DESCRIPTION OF THE DRAWINGS

FIG. 1 is a simulation screen using the automatic system of the present invention.

FIG. 2 is an architecture diagram of an automatic system for vision-guided navigation using real-time visual anchor point detection of the present invention.

FIG. 3 is a process of the present invention to automatically select a visual landmark image that best represents an intersection.

FIG. 4 is the process of automatically updating the landmark database according to the present invention.

FIG. 5 is a landmark record in the landmark database of the present invention.

FIG. 6 is a flow chart of the simulation used by the user of the present invention.

FIG. 7 is a route generated by navigation in an embodiment of the present invention.

### DETAILED DESCRIPTION OF THE INVENTION

In order to let the reviewer further understand the present invention, the preferred embodiment will be described in detail as the following description:

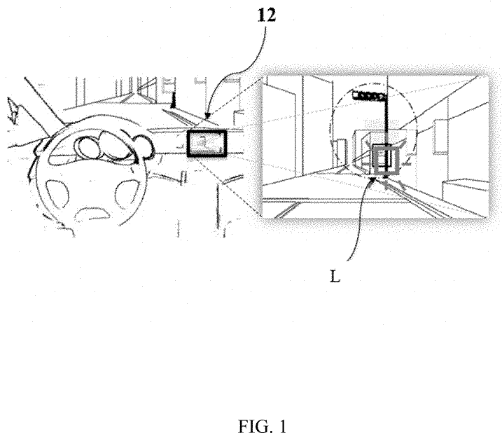

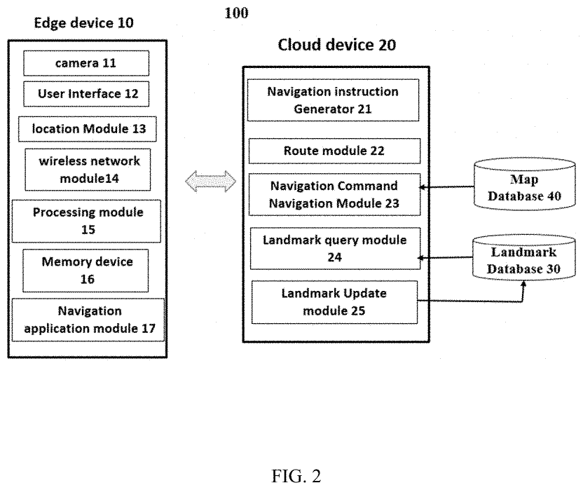

The present invention provides an automatic system for visual guidance and navigation using real-time visual anchor point detection, which is shown in FIG. 1 and FIG. 2. FIG. 1 is a simulation screen using the automatic system of the present invention. In order to solve the problems of the prior art, the present invention provides a system capable of realizing a more intuitive and precise navigation system.

FIG. 2 is an architecture diagram of an automatic system for vision-guided navigation using real-time visual anchor point detection 100 of the present invention, which includes: an edge device 10, a cloud device 20, and a landmark database 30. Wherein the edge device 10 comprises a camera 11 disposed on a vehicle for capturing a real-time image while the user is driving the vehicle; a user interface 12 that provides a user operation for viewing the information provided by the application, entering the user data and projects visual anchors; a location module 13 for determining the current geographic location of the vehicle; a wireless network module 14, transmitting the current geographic location of the vehicle and a destination set by the user to the wireless network module 14; a processing module 15, which can perform an edge computing, can process the real-time image and the current geographic location information of the vehicle in combination, and provide the user with a driving instruction through the user interface 12 wherein the instruction includes a candidate visual landmark image; a memory device 16 for ca ching a reference landmark image and data of the user received from the cloud server 14; and a navigation application module 17, the user can set the destination, transmit the vehicle location and destination to the wireless network module, obtain a route instruction and a landmark image information, and report to the user interface, wherein the user displays processing results and driving instructions.

Wherein, the cloud device 14 includes: a navigation instruction generator that generates a navigation instruction, and an action intersection; a route module, which queries the route from the landmark database according to the current geographic location of the vehicle and the destination; a navigation instruction generator 21, which generates the navigation instruction according to the route of the route module 22, and defines an action intersection according to the navigation instruction; a landmark query module 24 that queries visual landmark images from the landmark database 30 according to the action intersection; and a landmark update module 25, which automatically updates the visual landmark images of the landmark database 30. Wherein the landmark database 30 includes a landmark record, a visual landmark image, the intersection where the landmark is located, or the longitude and latitude of the landmark.

The processing module 15 further includes: receiving a candidate's visual landmark image at the current geographic location of the vehicle, and comparing the captured real-time image with the received candidate visual landmark image, to determine whether the candidate visual landmark image is visible in the real-time image; when the candidate visual landmark image is not visible in the real-time image, the candidate visual landmark image is deleted from the instruction. Also, the processing module 15 of the present invention determines whether the captured real-time image depicts an object of a predetermined object, and determines whether the object is visible within the real-time image based on at least one of the size or color of the object; if it is determined that the object is visible, the object is selected as the visual landmark image.

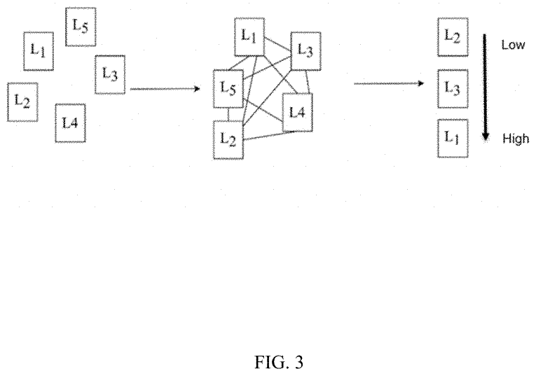

The present invention provides an automatic visual landmark image acquisition and landmark database update function as shown in FIG. 3, which is to automatically select a plurality of visual landmark images that best represent the intersection for similarity scoring. First, take two visual landmark images (L1, L2), and further calculate the similarity of the two visual landmark images for scoring, and then calculate the score (Confidence) of each landmark item through a function, Finally, all the icon images are sorted according to the scores, and the visual landmark image with the lower similarity score is selected as the new candidate visual landmark image.

For example, as shown in FIG. 3, if there are 5 visual landmark images at an intersection, they are the visual landmark image L1, the visual landmark image L2, the visual landmark image L3, the visual landmark image L4, and the visual landmark image L5 respectively. Compare the similarity between visual landmark images, L1 and L2, L2 and L3, L3 and L4, L4 and L5, L5 and L1, etc., The similarity between the visual landmark images L1 and L2 is compared, and then the similarity value S12 can be further obtained. The higher the similarity value is, the more similar the two visual landmark images are.

The similarity of these pairs (S12) was used to estimate the weight score of each landmark (Confidence), and then the five candidate landmarks are sorted according to this weight scores. Take L1 as an example, its C1=f(S1n) (n=2˜5). The lower the score, the less similar it is to other candidate landmarks, and the more representative it is. Therefore, it is used as the candidate landmark image of this intersection. In FIG. 3, L2 is the least similar to the other candidate landmarks, so it is selected as the new candidate landmark image for this intersection.

When a user loads the automatic system 100 of the present invention for visual guidance and navigation using real-time visual anchor point detection in a vehicle, the vehicles become data collectors and can function regardless of whether the vehicle is navigating. The present invention designs an automated system that can collect data from these vehicles, scale up with low labor costs , and quickly adapt to dynamically changing environments. The present invention uses camera 11 in the moving vehicle. Camera 11 can be installed in a preset location, and the location can be considered according to the size and type of the vehicle. Any location where it is convenient to collect video-related visual anchor features, collect videos to retrieve the set features of related visual anchors , the visual anchors include, but are not limited to signs, specific buildings, installation art, bridges, text, vehicles, billboards, traffic lights or portrait, and visual icon images. Each vehicle can be regarded as a visual landmark image collector. Each landmark image collector is equipped with a camera and a GPS sensor, so the GPS location of each video can be recorded. When the original video is collected, the landmark image detector detects visual anchors, and crops visual landmark images, which can be signs, specific buildings, installations, bridges, text, vehicles, billboards, traffic lights, or people. Thus, the system can collect multiple images of visual landmarks and their attributes, such as GPS locations.

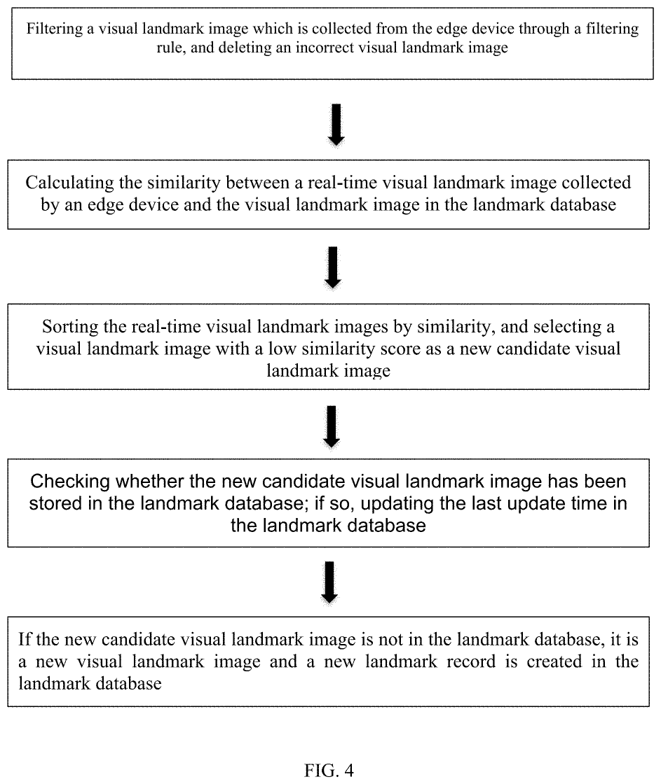

The system of the present invention executes an automatic update program and uses the collected visual landmark images to improve the landmark database, and the process is shown in FIG. 4. When the wireless network module receives multiple sets of real-time landmark images corresponding to an intersection from different vehicles, different weather conditions, or different daytimes, the wireless network module starts a landmark acquisition and update program. In a period, there may be multiple vehicles passing through the same intersection, the wireless network module can collect a large number of real-time landmark images and visual landmark images corresponding to the intersection through these vehicles, and select the candidate landmarks from these landmarks. The plurality of representative visual landmark images arranged in priority order are called “new candidate visual landmark images”, and compared with the visual landmark images in the landmark database for similarity comparison; finally, the landmark update module will use the selected better representative landmark images as the new landmark images in the landmark database.

### Embodiment 1. The Usage Scenario of Automatically Updating the Visual Landmark Images in the Landmark Database

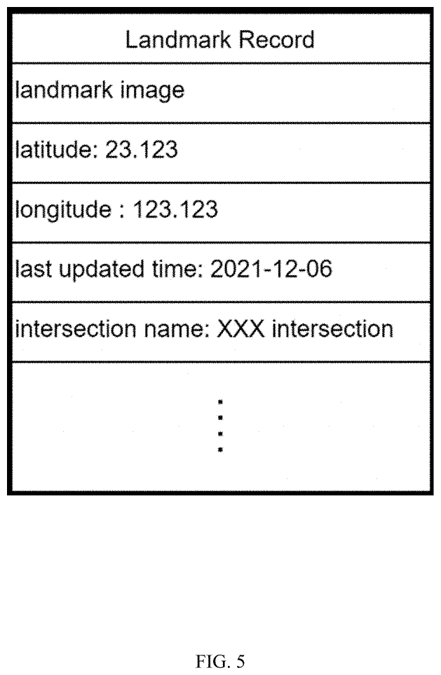

The present invention uses the automatic system and method of visual guidance navigation of real-time visual anchor point detection, can automatically update the visual landmark image in the landmark database, as shown in FIG. 5, it comprises the following steps:
(a) Use a rule to filter visual landmark images in the landmark database and remove incorrect visual landmark images;
(b) Calculate the similarity between the collected real-time visual landmark images and the visual landmark images in the landmark database;
(c) Sort the real-time visual landmark images, and select a plurality of visual landmark images with low similarity scores as new candidate visual landmark images;
(d) Check whether the new candidate visual landmark image has been stored in the landmark database; if so, update the last update time in the landmark database;
(e) If the new candidate visual landmark image is selected as the new visual landmark image, creating a new landmark record in the landmark database; and
(f) Check whether all landmark records of the current geographic location of the vehicle in the landmark database have reached the time limit to be updated; and if they have expired, then delete the landmark records.

### Embodiment 2 Simulate User Scenarios

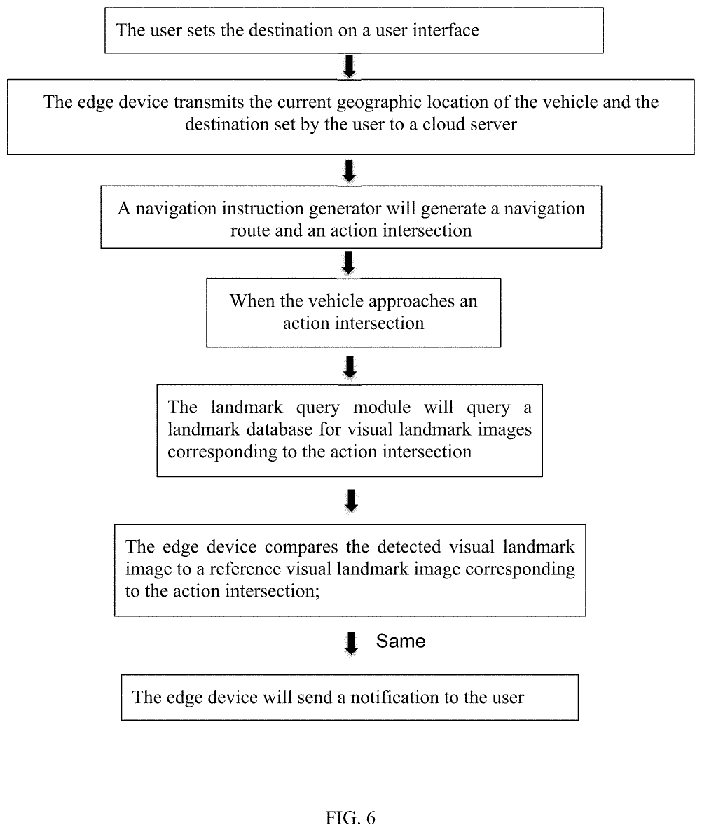

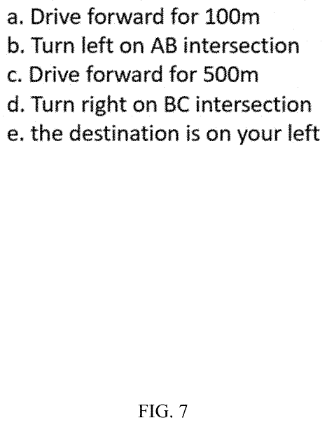

The present invention simulates the user scenario, and its process flow is shown in FIG. 6, which includes:
(a) A user installs the edge device as shown in FIG. 2 on a vehicle;
(b) The user sets the destination on a user interface;
(c) The edge device transmits the current geographic location of the vehicle and the destination set by the user to a wireless network module via a wireless network module 14;
(d) A navigation instruction generator 21 will generate a navigation route and an action intersection, as shown in FIG. 7;
(e) A landmark query module 24 will query a landmark database 30 for visual landmark images corresponding to the action intersection;
(f) The wireless network module 14 transmits the route with the visual landmark image to the edge corresponding to the action intersection;
(g) When the edge device 10 receives the route and the visual landmark image, it is called the reference landmark image;
(h) When the vehicle approaches an action intersection, the processing module 15 starts to detect the real-time visual landmark image collected by camera 11 in real-time;
(i) The edge device 10 compares the detected visual landmark image to a reference visual landmark image corresponding to the action intersection; if the detected real-time landmark image is the same as the reference visual landmark image, the edge device will send a notification to the user, as shown in FIG. 1;
(j) The processing module 15 transmits all detected real-time visual landmark images along with GPS information to the wireless network module 14; and
(k) The wireless network module 14 receives these landmark images and executes a landmark database update procedure, as shown in FIG. 4.

Taking FIG. 7 as an example, this is a route generated by navigation, in which steps b and c are operation steps, the navigation system should tell the user the route guidance, AB intersection, and BC intersection are action intersections.

In summary, in the present invention, the wireless network module 14, the map database 40, the landmark database 30, and the application program running on the edge device are formed. The map database 40 contains map information such as intersections, latitude and longitude of intersections, and road travel directions. The landmark database 30 includes a landmark record, a picture corresponding to the landmark, the intersection where the landmark is located, and the latitude and longitude of the landmark. On the wireless network module 14 sides, the database stores multiple landmark records as shown in FIG. 5, which include collected visual anchors (ex, signs, storefront signs, buildings, installations, bridges, text, vehicles, billboards, traffic lights, or portraits), these anchors are cropped and labeled from some street video or visual landmark images at each intersection, along with their GPS coordinates. In addition, the present invention has two modules interactively connected to the database, a landmark query module 24 queries the reference landmark image through guidance instructions, and a landmark update module 25 automatically updates the landmark database 30.

In edge device 10, a processing module is used for connecting with the server and collecting images to provide a visual guidance function for the user. When a route is planned and all action points are obtained by the navigation instruction generator, the visual anchors and their features for each action point are retrieved from the landmark database. When the user approaches the action point notified by the navigation engine, the processing module will find the corresponding visual anchor by comparing the features of the visual anchor with the features of the sign/landmark image in the video, and the visual anchor will be displayed on the user interface.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A method of automatically updating visual landmark images in a landmark database, which includes:
(a) Filtering a visual landmark image which is collected from the edge device through a filtering rule, and deleting an incorrect visual landmark image;
(b) Calculating the similarity between a real-time visual landmark image collected by an edge device and the visual landmark image in the landmark database;
(c) Sorting the real-time visual landmark images by similarity, and selecting a visual landmark image with a low similarity score as a new candidate visual landmark image;
(d) Checking whether the new candidate visual landmark image has been stored in the landmark database; if so, updating the last update time in the landmark database;
(e) If the new candidate visual landmark image is not in the landmark database, it is a new visual landmark image and a new landmark record is created in the landmark database; and
(f) Checking whether all landmark records of the current geographic location of the vehicle in the landmark database have reached the deadline for updating, and if they have expired, delete the landmark records.

2. The method for automatically updating the visual landmark image in the landmark database of claim 1, wherein the filtering rule includes a region parameter filtering rule or an aspect ratio parameter filtering rule.

3. The method for automatically updating the visual landmark image in the landmark database of claim 1, wherein the filtering rule further comprises: receiving a candidate visual landmark image in the current geographic location of the vehicle, the captured real-time image is compared with the received candidate visual landmark image to determine whether the candidate visual landmark is visible in the real-time image; when the candidate visual landmark image is not available in the real-time image, the candidate visual landmark image is deleted from the instruction.

4. The method for automatically updating the visual landmark image in the landmark database of claim 3, wherein the filtering rule further comprises: sending the captured real-time image to the server system, wherein the server system determines that all whether the candidate visual landmark is visible in the real-time image; if visible, receive the instruction from the server system.

5. The method for automatically updating the visual landmark image in the landmark database of claim 3, wherein the filtering rule further comprises: determining whether the captured real-time image depicts an object of a predetermined category, based on the object's at least one of size or color, determining whether the object is visible in the real-time image; if it is determined that the object is visible, selecting the object as the visual landmark image.

6. The method for automatically updating the visual landmark image in the landmark database of claim 5, wherein the certain predetermined category includes storefront signs, buildings, installation art, bridges, text, vehicles, billboards, traffic lights, or portraits.

7. The method for automatically updating the visual landmark image in the landmark database of claim 1, comprising determining the weather conditions of the current location of the vehicle, retrieving a plurality of visual landmark images in the landmark database, and calculating the most visible visual landmark for different weather conditions.

8. The method for automatically updating the visual landmark image in the landmark database of claim 1, further before retrieving the plurality of visual landmarks, receiving a selection of the type of visual landmark corresponding to the time of a day or a season from the user.

9. The method for automatically updating the visual landmark image in the landmark database of claim 2, wherein the area parameter (frame area) filtering rule is to filter the area of the landmark picture, and the landmark picture is less than 1/1000 and/or greater than ¼ will be deleted.

10. The method for automatically updating the visual landmark image in the landmark database of claim 2, wherein the filtering rule of the aspect ratio parameter is to select a visual landmark image that should be larger than ⅕ and/or smaller than 5 between.

11. A method of vision-guided navigation using real-time visual anchor point detection, comprising:
(a) Obtaining a route for guiding a vehicle user to a destination through a processing module;
(b) Retrieving from a database a visual landmark image positioned along the route through the processing module;
(c) Capturing a real-time landmark image from a predetermined location of the user during navigation along the route via a camera;
(d) Using the retrieved visual landmark image and the collected real-time landmark image, and performing an edge calculation through the processing module, the real-time image and the geographic location of the vehicle can be processed, wherein the user is provided with a driving instruction via the user interface and the driving instruction is including a candidate visual landmark image.

12. The method of vision-guided navigation using real-time visual anchor point detection of claim 11, wherein the visual landmark image in the processing module can be automatically updated, which includes the following steps:
(a) Filtering a visual landmark image which is collected from the edge device through a filtering rule, and deleting an incorrect visual landmark image;
(b) Calculating the similarity between the collected real-time visual landmark images and the visual landmark images in the landmark database;
(c) Sorting the similarity of the real-time visual landmark images and selecting a plurality of visual landmark images with low similarity scores as new candidate visual landmark images;
(d) Checking whether the new candidate visual landmark image has been stored in the landmark database; if so, updating the last update time in the landmark database;
(e) If the new candidate visual landmark image is not in the landmark database, then creating a new landmark record in the landmark database; and
(f) Checking whether all the landmark images of the current geographic location of the vehicle in the landmark database have reached the time limit to be updated, and if they have expired, delete the landmark records.

13. The method of vision-guided navigation using real-time visual anchor point detection of claim 12, wherein the filtering rule includes a region parameter filtering rule or an aspect ratio parameter filtering rule.

14. An automatic system for vision-guided navigation using real-time visual anchor point detection, which includes an edge computing device, a cloud device, and a landmark database, wherein the edge computing device includes:
a camera disposed on a vehicle for capturing a real-time image while the user is driving the vehicle;
a user interface that provides a user operation for viewing the information provided by the application, entering the user data and objects visual anchors;
a location module for determining the current geographic location of the vehicle;
a wireless network module, transmitting the current geographic location of the vehicle and a destination set by the user to the wireless network module;
a processing module, which can perform an edge computing, process the real-time image and the current geographic location information of the vehicle in combination and provide the user with a driving instruction through the user interface after processing, wherein the driving instruction includes a candidate visual landmark image;
a memory device for caching a reference landmark image and data of the user received from the wireless network module; and
a navigation application module, the user can set the destination, transmit the vehicle location and destination to the wireless network module, obtain a route instruction and a landmark image information, and report to the user interface, wherein the user displays processing results and driving instructions;
wherein, the cloud device includes:
a navigation instruction generator that generates a navigation instruction, and an action intersection;
a route module, which queries the route from the landmark database according to the current geographic location of the vehicle and the destination;
a navigation instruction generator, which generates the navigation instruction according to the route of the route module, and defines an action intersection according to the navigation instruction;
a landmark query module, which queries visual landmark images from the landmark database according to the action intersection; and
a landmark update module, which automatically updates the visual landmark images of the landmark database;
wherein, the landmark database includes a landmark record, a visual landmark image, the intersection where the landmark is located, or the longitude and latitude of the landmark.

15. The automatic system for vision-guided navigation of claim 14, wherein the processing module further comprises: receiving a candidate visual landmark image at the current geographic location of the vehicle, and comparing the captured real-time image with the received candidate visual landmark image; wherein the candidate visual landmarks are compared to determine whether the candidate visual landmark image is visible in the real-time image; when the candidate visual landmark image is not visible in the real-time image, the candidate visual landmark image is deleted from the instruction.

16. The automatic system for vision-guided navigation of claim 14, wherein the filtering rule filtering further comprises: sending the captured real-time image to the server system, wherein the server system determines whether the candidate visual landmark is visible in the real-time image; if visible, the instruction is received from the server system.

17. The automatic system for vision-guided navigation of claim 14, which further comprises: determining whether the captured real-time image depicts an object of a predetermined object, and determines whether the object is visible within the real-time image based on at least one of the size or colors of the object; if it is determined that the object is visible, the object is selected as the visual landmark image.

18. The automatic system for vision-guided navigation of claim 14, wherein the certain predetermined category of the present invention includes storefront signs, buildings, installation art, bridges, texts, vehicles, billboards, traffic lights, or portraits.

19. The automatic system for visual guidance navigation of claim 14, wherein the visual landmark images in the landmark database can be automatically updated, comprises the following steps:
(a) Filtering a visual landmark image which is collected from the edge device through a filtering rule, and deleting an incorrect visual landmark image;
(b) Calculating the similarity between the collected real-time visual landmark images and the visual landmark images in the landmark database;
(c) Sorting the real-time visual landmark images, and select a plurality of visual landmark images with low similarity scores as new candidate visual landmark images;
(d) Checking whether the new candidate visual landmark image has been stored in the landmark database; if so, update the last update time in the landmark database;
(e) If the new candidate visual landmark image is not in the landmark database, then it is a new visual landmark image, creating a new landmark record in the landmark database; and
(f) Checking whether all landmark records of the current geographic location of the vehicle in the landmark database have reached the time limit to be updated, and if they have expired, deleting the landmark records.

20. The automatic system for vision-guided navigation of claim 19, wherein the filtering rule is a frame area filtering rule or an aspect ratio parameter filtering rule.
